(19) United States
(12) Patent Application Publication
(10) Pub. No.: US 2025/0093586 A1
(43) Pub. Date: Mar. 20, 2025

(54) METHOD FOR CONNECTING OPTICAL WAVEGUIDE AND OPTICAL WAVEGUIDE CONNECTION DEVICE

(71) Applicant: Panasonic Intellectual Property Management Co., Ltd., Osaka (JP)

(72) Inventors: JUNICHI KAMATANI, Nara (JP); TATSURO SHIRAISHI, Osaka (JP)

(21) Appl. No.: 18/964,616

(22) Filed: Dec. 1, 2024

Related U.S. Application Data
(63) Continuation of application No. PCT/JP2023/016052, filed on Apr. 24, 2023.

(30) Foreign Application Priority Data
Jun. 16, 2022 (JP) 2022-097376

(51) Int. Cl. G02B 6/36

(52) U.S. Cl. CPC G02B 6/3616

(57) ABSTRACT

A method for connecting an optical waveguide includes supplying adhesive (3) to near a light input unit on an optical circuit board, aligning optical fiber block (2) holding optical fiber (2a) with respect to the optical circuit board to maximize intensity of light emitted from the optical circuit board, starting curing of the adhesive, measuring a curing degree of the adhesive and an adhesive curing time during the curing of the adhesive, and repeating the alignment of the optical fiber block holding the optical fiber with respect to the optical circuit board to maximize the intensity of the light emitted from the optical circuit board in a state where the degree of curing is less than or equal to a certain threshold value.

### TECHNICAL FIELD

The present disclosure relates to a method for connecting an optical waveguide, and an optical waveguide connection device.

### BACKGROUND ART

In recent years, utilization of light has been explored in the fields of high-speed communication, large-capacity communication, and sensing. In particular, a technology called “silicon photonics” has been attracting attention. Silicon photonics is a technology for forming an optical circuit on a silicon substrate using a complementary metal oxide semiconductor (CMOS) process, in the same manner as for semiconductor electronic circuits. Optical circuits fabricated by silicon photonics are microscopic circuits with a light control function. Elements such as light input/output units and an optical modulator are implemented on an optical circuit. These elements are connected to one another using an extremely fine optical waveguide, which is in the order of submicron. In order to connect an external transfer medium such as an optical fiber to the optical waveguide at a high precision, efforts for developing various types of optical interface are being made actively.

In general, as a method for connecting an optical fiber to an optical waveguide on an optical circuit board (that is, fiber-to-chip connection), a method for using adhesive has been used. With this method, an end face of a light input unit, which is formed on the optical circuit board, is bonded and fixed to the entire connected end face of an optical fiber array or an optical fiber block where one or more optical fibers are bundled, via an adhesive.

In a case where this method is adopted to fix the optical fiber block to the optical circuit board, it is known that when the adhesive is cured, a relative position between the optical circuit board and the optical fiber block is shifted due to curing shrinkage of the adhesive and a connection loss occurs.

PTL 1 discloses that an adhesive protruding from a lower surface of a ferrule is absorbed by a groove due to a capillary phenomenon by providing the groove along an end (periphery) of the lower surface of the ferrule holding an optical fiber, adhesion of the adhesive to a side surface of the ferrule is prevented, and positional shift of the ferrule in a parallel direction due to curing shrinkage is suppressed.

### CITATION LIST

### Patent Literature

PTL 1: Unexamined Japanese Patent Publication No. 2019-144434

### SUMMARY OF THE INVENTION

A method for connecting an optical waveguide according to an aspect of the present disclosure includes supplying an adhesive to near a light input unit on an optical circuit board, aligning an optical fiber block holding an optical fiber with respect to the optical circuit board to maximize intensity of light emitted from the optical circuit board, starting curing of the adhesive, measuring a degree of curing of the adhesive, measuring an adhesive curing time during the curing of the adhesive, and aligning the optical fiber block holding the optical fiber with respect to the optical circuit board to maximize the intensity of the light emitted from the optical circuit board while referring to the degree of curing of the adhesive and the adhesive curing time.

An optical waveguide connection device according to another aspect of the present disclosure includes an adhesive supply unit that supplies an adhesive to near a light input unit provided in an optical circuit board, a light receiving unit that receives light emitted from the optical circuit board, an optical fiber aligning mechanism that aligns an optical fiber block holding an optical fiber with respect to the optical circuit board to maximize intensity of light received by the light receiving unit in a state where the adhesive is supplied, an adhesive curing unit that cures the adhesive, an adhesive curing time detection mechanism that detects a curing time of the adhesive when the adhesive is cured, a degree-of-curing measurement unit that measures a degree of curing of the adhesive, and a controller that controls the optical fiber aligning mechanism. The optical fiber block holding the optical fiber is aligned with respect to the optical circuit board by the optical fiber aligning mechanism to maximize the intensity of the light emitted from the optical circuit board while referring to the degree of curing of the adhesive and the curing time of the adhesive by control of the controller.

### BRIEF DESCRIPTION OF THE DRAWINGS

FIG. 1 is a diagram illustrating a configuration example of an optical waveguide connection device according to a first exemplary embodiment of the present disclosure.

FIG. 2 is a control system diagram of the optical waveguide connection device according to the first exemplary embodiment of the present disclosure.

FIG. 3 is a flowchart illustrating a method for connecting an optical waveguide according to the first exemplary embodiment of the present disclosure.

FIG. 4 is a diagram for explaining a change in a resistance value according to the first exemplary embodiment of the present disclosure.

FIG. 5 is a diagram illustrating a configuration example of an optical waveguide connection device according to a second exemplary embodiment of the present disclosure.

FIG. 6 is a control system diagram of the optical waveguide connection device according to the second exemplary embodiment of the present disclosure.

FIG. 7 is a flowchart illustrating a method for connecting an optical waveguide according to the second exemplary embodiment of the present disclosure.

FIG. 8 is a diagram for explaining a change in a degree of curing according to the second exemplary embodiment of the present disclosure.

### DESCRIPTION OF EMBODIMENT

In the related art disclosed in PTL 1, it is necessary to additionally perform fine machining on the ferrule, and an increase in manufacturing cost may be caused. In addition, when the adhesive is supplied, it is necessary to stay in an applied region on the optical circuit board to some extent, and viscosity of the adhesive and an application amount of the adhesive are limited.

An object of a non-limiting example of the present disclosure is to provide a method for connecting an optical waveguide and an optical waveguide connection device capable of suppressing positional deviation between an optical fiber and a light input unit of an optical circuit board with a simple configuration regardless of a shape of an adhesion object and realizing highly efficient optical coupling.

Hereinafter, preferred exemplary embodiments of the present disclosure will be described in detail with reference to the drawings.

Note that, in the present specification and the drawings, constituent elements having substantially identical functional functions are denoted by the same reference marks, and thus, duplicate description will be omitted. In the following drawings, shapes, thicknesses, lengths, or the like of constituent members to be illustrated below are different from shapes, thicknesses, lengths, or the like of actual component members. Further, materials of such constituent members are not limited to materials described in the present exemplary embodiment.

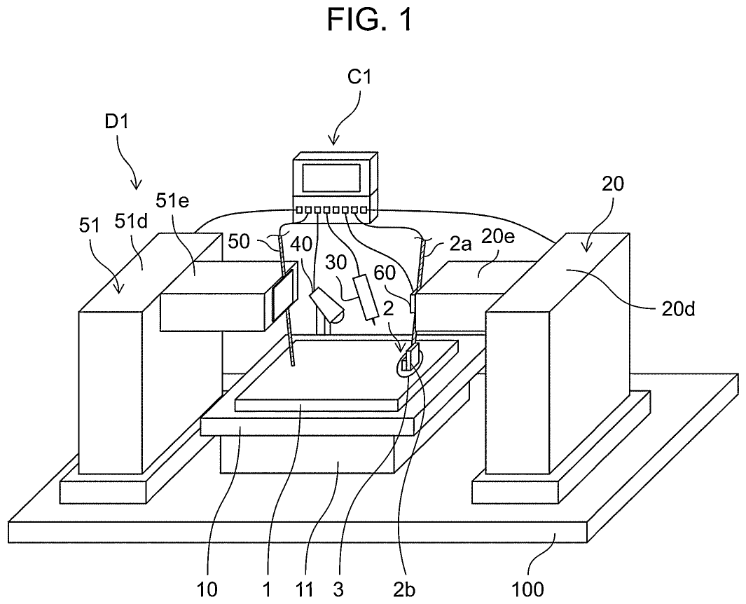

In FIG. 1 and subsequent drawings, an X-axis direction, a Y-axis direction, and a Z-axis direction represent a direction parallel to an X-axis, a direction parallel to a Y-axis, and a direction parallel to a Z-axis, respectively. The X-axis direction and the Y-axis direction are orthogonal to each other. The X-axis direction and the Z-axis direction are orthogonal to each other. The Y-axis direction and the Z-axis direction are orthogonal to each other. An XY plane represents a virtual plane parallel to the X-axis direction and the Y-axis direction. An XZ plane represents a virtual plane parallel to the X-axis direction and the Z-axis direction. A YZ plane represents a virtual plane parallel to the Y-axis direction and the Z-axis direction. In addition, in FIG. 1 and subsequent drawings, a direction indicated by an arrow in the X-axis direction corresponds to a positive X-axis direction, and a direction opposite to the direction corresponds to a negative X-axis direction. In addition, in FIG. 1 and subsequent drawings, a direction indicated by an arrow in the Y-axis direction corresponds to a positive Y-axis direction, and a direction opposite to the direction corresponds to a negative Y-axis direction. In addition, in FIG. 1 and subsequent drawings, a direction indicated by an arrow in the Z-axis direction corresponds to a positive Z-axis direction, and a direction opposite to the direction corresponds to a negative Z-axis direction. The Z-axis direction is equal to, for example, a vertical direction or an up-down direction, for example, a thickness direction of optical circuit board 1 having a rectangular shape, and the X-axis direction and the Y-axis direction are equal to, for example, a horizontal direction or a left-right direction, for example, a long side direction and a short side direction of rectangular optical circuit board 1.

### First Exemplary Embodiment

### <Optical Waveguide Connection Device>

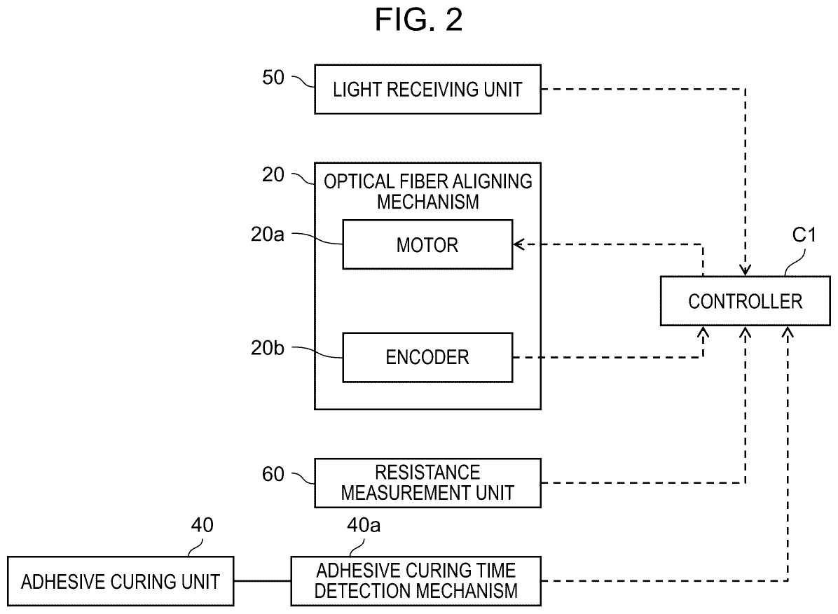

To begin with, optical waveguide connection device D1 according to a first exemplary embodiment of the present disclosure will be explained with reference to FIGS. 1 and 2. FIG. 1 is a diagram illustrating a configuration example of optical waveguide connection device D1 according to the first exemplary embodiment of the present disclosure, and FIG. 2 is a control system diagram of optical waveguide connection device D1 according to the first exemplary embodiment of the present disclosure. Optical waveguide connection device D1 is a device that actively aligns and connects optical circuit board 1 and optical fiber block 2. A case where the optical circuit board and the optical fiber block are actively aligned means that light intensity received by light receiving unit 50 is measured with a measuring device (not illustrated) and optical axis alignment between optical fiber block 2 and optical circuit board 1 is performed to maximize the measured light intensity. In the first exemplary embodiment, a case where the optical fiber block is actively aligned may be referred to as “active alignment”.

Optical waveguide connection device D1 includes at least sample stage 10, optical fiber aligning mechanism 20, adhesive supply unit 30, adhesive curing unit 40, adhesive curing time detection mechanism 40a, light receiving unit 50, resistance measurement unit 60, and controller C1. Further, optical waveguide connection device D1 may include sample adjustment mechanism 11 and light receiving unit aligning mechanism 51.

Sample stage 10 is provided on fixing base 100, and is a base on which optical circuit board 1 is installed. Sample stage 10 may be of any type as long as optical circuit board 1 can be installed. For example, sample stage 10 may be provided with an adsorption hole for adsorbing optical circuit board 1, and optical circuit board 1 may be brought into close contact with sample stage 10 by applying a negative pressure to the adsorption hole.

Sample adjustment mechanism 11 is a mechanism that is provided between fixing base 100 and sample stage 10 and adjusts a position of optical circuit board 1 on sample stage 10. Specifically, the position of optical circuit board 1 is adjusted such that light emitted from optical fiber block 2 is roughly coupled to optical circuit board 1. Sample adjustment mechanism 11 is, for example, a unit in which two linear motion stages are combined in an orthogonal direction. For adjusting the position of optical circuit board 1, for example, a camera or the like may be used.

Optical fiber aligning mechanism 20 is a movable stage that is provided near sample stage 10 of fixing base 100 and allows first movable unit 20e to move in an XYZ-axis direction with respect to first fixing unit 20d to perform active alignment of optical fiber block 2 held by first movable unit 20e. Optical fiber aligning mechanism 20 aligns optical fiber block 2 holding optical fiber 2a with respect to optical circuit board 1 to maximize the intensity of the light received by light receiving unit 50 in a state where adhesive 3 is supplied. Specifically, the alignment by optical fiber aligning mechanism 20 is repeatedly performed even while adhesive 3 is cured by adhesive curing unit 40 to be described later in a case where a resistance value measured by resistance measurement unit 60 to be described later is less than or equal to a threshold value. Here, optical fiber block 2 includes optical fiber 2a and holder 2b. Optical fiber 2a is a medium that transmits light, and examples of which include a single mode fiber, a multi-mode fiber, a quartz fiber, and a plastic fiber. Optical fiber block 2 may be of any type as long as optical fiber 2a is held. Optical fiber aligning mechanism 20 is realized by combining, for example, a linear motion stage using a linear ball guide, a gonio stage, or the like. Motor 20a and encoder 20b are provided with respect to each axial direction in optical fiber aligning mechanism 20. Positional information of optical fiber block 2 detected by encoder 20b is input to controller C1. First movable unit 20e of optical fiber aligning mechanism 20 is configured to be movable in six axial directions different from each other, for example. The six axis directions include, for example, the X-axis direction, the Y-axis direction, the Z-axis direction, and a rotation direction around each of these axes. Note that, a movable direction of optical fiber aligning mechanism 20 may be any one of six axes. However, in a case where the movable direction of optical fiber aligning mechanism 20 is 6 axes, since a fine operation can be realized in each step in a method for connecting an optical waveguide to be described later, accuracy of alignment is improved, and high quality and high efficiency optical coupling can be realized.

Adhesive supply unit 30 is a unit that supplies adhesive 3 to near a light input unit (not illustrated) on optical circuit board 1. A component of adhesive 3 include a photocurable or thermosetting resin such as an acrylic resin, an epoxy resin, an acrylic epoxy resin, or a silicon resin. Adhesive supply unit 30 is, for example, a dispenser. Adhesive supply unit 30 may be of any type as long as adhesive 3 can be supplied onto optical circuit board 1. A supply amount of adhesive 3 supplied by adhesive supply unit 30 is, for example, 10 [nL] to 1000 [μL].

Adhesive curing unit 40 is a unit for fixing optical fiber block 2 onto optical circuit board 1 by curing adhesive 3 supplied onto optical circuit board 1 in a state where optical fiber block 2 is aligned with respect to optical circuit board 1. Adhesive curing unit 40 is, for example, an ultraviolet light source, and a heater may be used in accordance with the type of adhesive 3. In optical waveguide connection device D1 of the present disclosure, one adhesive curing unit is used as the ultraviolet light source, but a plurality of adhesive curing units may be provided in accordance with the connection configuration. Adhesive curing time detection mechanism 40a is a count-up timer that detects a time during which adhesive 3 is cured by adhesive curing unit 40. Time information detected by adhesive curing time detection mechanism 40a is input to controller C1.

Light receiving unit 50 is a unit that receives light emitted from optical circuit board 1, and is, for example, an optical fiber. Intensity information of the light received by light receiving unit 50 is input to controller C1.

Light receiving unit aligning mechanism 51 is a movable stage that is provided near sample stage 10 of fixing base 100 to face optical fiber aligning mechanism 20 and in which second movable unit 15e is movable in the XYZ-axis direction with respect to second fixing unit 51d to adjust the position of light receiving unit 50 held by second movable unit 51e. Light receiving unit aligning mechanism 51 is realized by combining, for example, a linear motion stage using a linear ball guide, a gonio stage, or the like. Second movable unit 51e of light receiving unit aligning mechanism 51 is configured to be able to operate, for example, in six axial directions different from each other. The six axis directions include, for example, the X-axis direction, the Y-axis direction, the Z-axis direction, and a rotation direction around each of these axes. Note that, the movable direction of light receiving unit aligning mechanism 51 may be any one of six axes. However, in a case where the movable direction of light receiving unit aligning mechanism 51 is 6 axes, since the fine operation can be realized in each step in the method for connecting an optical waveguide to be described later, the accuracy of alignment is improved, and the high quality and high efficiency optical coupling can be realized.

Resistance measurement unit 60 is a unit that functions as an example of a degree-of-curing measurement unit that measures a degree of curing of adhesive 3 and measures the degree of curing of adhesive 3 by measuring a resistance value applied to optical fiber block 2 when optical circuit board 1 and optical fiber block 2 are actively aligned. Resistance measurement unit 60 is provided in a holding portion of optical fiber block 2, and is, for example, a piezoelectric force sensor. Voltage and force information measured by resistance measurement unit 60 are input to controller C1. The resistance value measured by resistance measurement unit 60 increases due to an increase in viscosity as the curing of adhesive 3 proceeds, and optical fiber block 2 cannot follow an operation of optical fiber aligning mechanism 20. When a mass of optical fiber block 2 is m, a moving speed of optical fiber block 2 given by optical fiber aligning mechanism 20 is v(t), and a viscous resistance of adhesive 3 is η, resistance force F applied to optical fiber block 2 is expressed by the following equation.

$$F = - η \times v ( t ) \qquad [ Math . 1 ]$$

Here, the following equation is represented by solving the equation of (Equation 1) for v(t).

$$v ( t ) = v ( 0 ) \times {e}^{- η \times t / m} \qquad [ Math . 2 ]$$

Accordingly, as the curing of adhesive 3 progresses, the moving speed of optical fiber block 2 decreases. An alignment operation when adhesive 3 is cured by adhesive curing unit 40 is repeatedly performed in a case where the resistance value measured by resistance measurement unit 60 is less than or equal to the threshold value, and the threshold value of the resistance value is appropriately set according to physical properties of adhesive 3 to be used and the shape of optical fiber block 2.

Controller C1 is a microcomputer or the like that controls operations of members constituting optical waveguide connection device D1. Controller C1 controls (actively aligns) optical fiber aligning mechanism 20 to maximize the intensity of the light detected by light receiving unit 50. In addition, controller C1 controls the supply amount of adhesive supply unit 30, irradiation intensity and an irradiation time of adhesive curing unit 40, and the like. In addition, in a case where a curing time detected by adhesive curing time detection mechanism 40a has not reached an irradiation time set by adhesive curing unit 40 described above and the resistance value measured by resistance measurement unit 60 has not reached the threshold value, controller C1 repeatedly controls (actively aligns) optical fiber aligning mechanism 20 to maximize the intensity of the light detected by light receiving unit 50.

### <Method for Connecting Optical Waveguide>

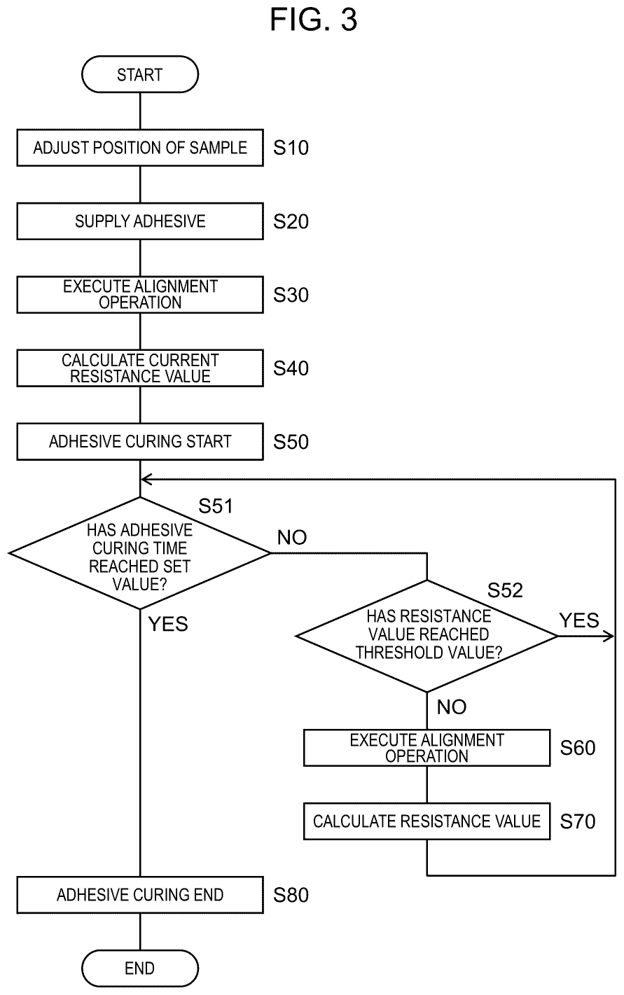

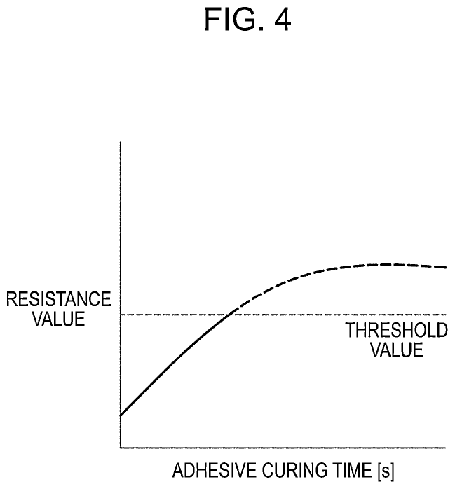

Next, a method for connecting an optical waveguide using optical waveguide connection device D1 according to the first exemplary embodiment of the present disclosure will be described with reference to FIGS. 3 and 4. FIG. 3 is a flowchart for explaining a method for connecting an optical waveguide according to the first exemplary embodiment of the present disclosure, and FIG. 4 is a diagram for explaining a change in the resistance value according to the first exemplary embodiment of the present disclosure.

First, the position of optical circuit board 1 is adjusted (step S10). In step S10, optical circuit board 1 is installed on sample stage 10, and the position of optical circuit board 1 is adjusted by, for example, sample adjustment mechanism 11.

Subsequently, adhesive 3 is supplied to near a light input unit (not illustrated) on optical circuit board 1 by adhesive supply unit 30 (step S20). A position where adhesive 3 is supplied may be appropriately set within a range where optical circuit board 1 and optical fiber block 2 can be connected and fixed, and adhesive 3 may be supplied to a plurality of places.

Subsequently, the alignment operation of optical fiber block 2 with respect to optical circuit board 1 is executed (step S30). The alignment operation is an operation of moving optical fiber block 2 to a predetermined position in the XY plane with respect to a light input unit (not illustrated) on optical circuit board 1. The predetermined position is a position of optical fiber block 2 in the XY plane where the intensity of the light emitted from a light output unit (not illustrated) on optical circuit board 1 is maximized in accordance with the light emitted to a light input unit via optical fiber 2a of optical fiber block 2. Optical fiber block 2 is moved to the predetermined position, and thus, an optical axis of optical fiber block 2 is aligned with respect to optical circuit board 1. The light emitted from a light output unit (not illustrated) of optical circuit board 1 may be received by light receiving unit 50, and the position of light receiving unit 50 may be adjusted by light receiving unit aligning mechanism 51. The accuracy of alignment of the optical axis of optical fiber block 2 by the operation in step S30 is in the order of nanometers. Note that, the accuracy of alignment in the operation of step S30 is not limited to the order of nanometers, and may be executed in the order of micrometers.

Subsequently, the resistance value applied to optical fiber block 2 is calculated by resistance measurement unit 60, and a reference value for calculating the degree of curing of adhesive 3 is measured (step S40). The measurement of the resistance value is performed when optical fiber block 2 is aligned in step S30, and indicates how much force optical fiber block 2 receives with respect to the alignment operation of optical fiber aligning mechanism 20. The resistance value is used for determination of execution of the alignment operation while adhesive 3 to be described later is cured.

Subsequently, the curing of adhesive 3 is started in a state where optical circuit board 1 and optical fiber block 2 are aligned via adhesive 3 (step S50). In step S50, adhesive 3 is cured by determining, by adhesive curing unit 40, the curing time of adhesive 3 and then irradiating adhesive 3 with ultraviolet rays or increasing an ambient temperature.

Subsequently, in a case where the time detected by adhesive curing time detection mechanism 40a has not reached a set value after the start of curing of adhesive 3 (step S51, NO), and in a case where the resistance value calculated in step S40 has not reached the threshold value (step S52, NO), the alignment operation of optical fiber block 2 is executed on optical circuit board 1 (step S60). In step S60, it is possible to correct positional deviation due to curing shrinkage of adhesive 3 caused by the curing of adhesive 3.

Subsequently, the resistance value applied to optical fiber block 2 in the alignment operation executed in step S60 is calculated by resistance measurement unit 60, the degree of curing of adhesive 3 is calculated based on a previously measured reference value (step S70), and processing in and after step S50 is repeatedly executed.

As illustrated in FIG. 4, as the curing time of adhesive 3 elapses, the viscosity changes, and the resistance value increases. In a case where the resistance value applied to optical fiber block 2 calculated in step S70 has reached the threshold value (step S52, YES), the alignment operation of optical fiber block 2 with respect to optical circuit board 1 is not executed, and when the adhesive curing time has reached the set value (step S51, YES), the curing of adhesive 3 is ended (step S80). Note that, the threshold value of the resistance value is appropriately set depending on the physical properties of adhesive 3 to be used and the shape of optical fiber block 2.

Through the above steps, the optical waveguide is connected.

According to the first exemplary embodiment, optical fiber block 2 holding optical fiber 2a can be aligned with optical circuit board 1 to maximize the intensity of the light emitted from optical circuit board 1 while referring to the degree of curing of adhesive 3 and the adhesive curing time. Specifically, as described above, step S51, step S52, step S60, and step S70 after step S50 are repeatedly performed. With this configuration, it is possible to suppress positional deviation between optical fiber 2a and the light input unit of the optical circuit board with a simple configuration regardless of a shape of an adhesion object such as optical fiber block 2, and it is possible to realize highly efficient optical coupling.

### Second Exemplary Embodiment

Hereinafter, a second exemplary embodiment of the present disclosure will be described with reference to the drawings. Note that, in the following description, differences from the first exemplary embodiment will be mainly described, and description of common points will be appropriately omitted or simplified.

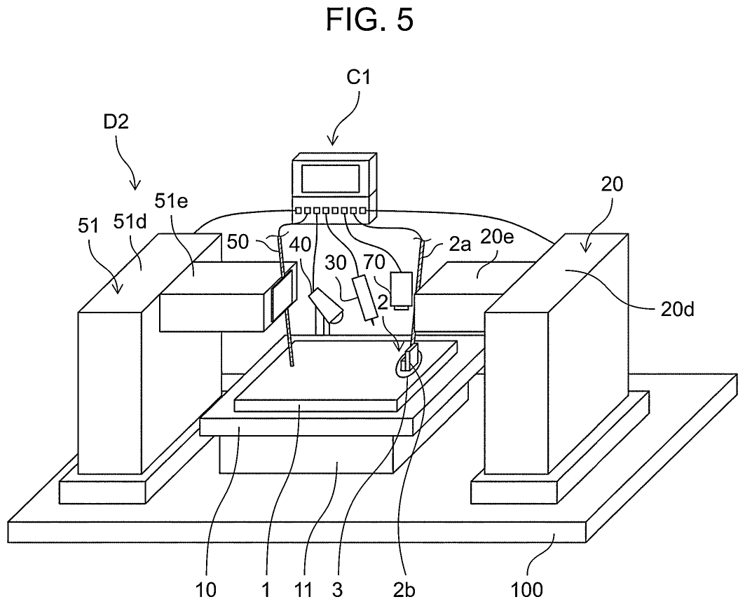

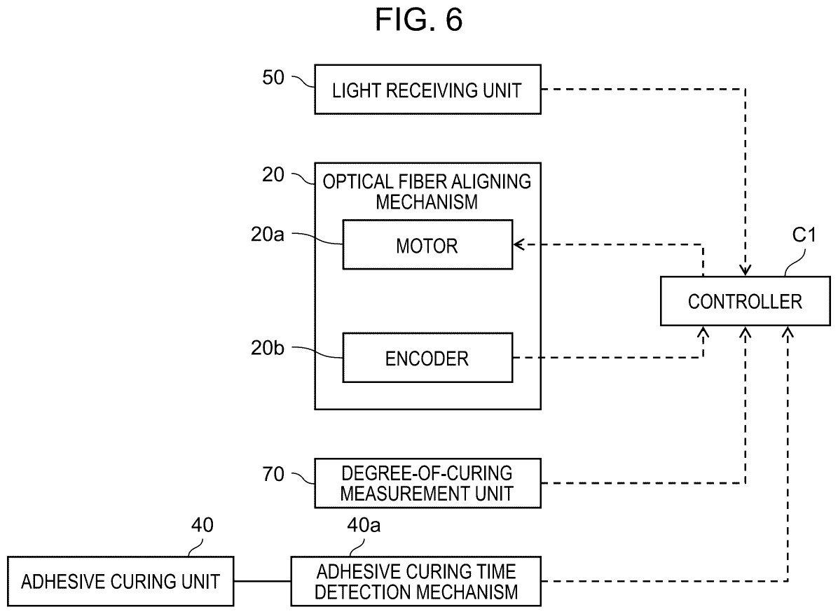

Optical waveguide connection device D2 according to the second exemplary embodiment of the present disclosure will be described with reference to FIGS. 5 and 6. FIG. 5 is a diagram illustrating a configuration example of optical waveguide connection device D2 according to the second exemplary embodiment of the present disclosure, and FIG. 6 is a control system diagram of optical waveguide connection device D2 according to the second exemplary embodiment of the present disclosure.

Optical waveguide connection device D2 according to the second exemplary embodiment includes degree-of-curing measurement unit 70 instead of resistance measurement unit 60.

Degree-of-curing measurement unit 70 is a unit that measures a degree of curing degree of adhesive 3 when adhesive 3 is cured by adhesive curing unit 40. For example, in a case where adhesive 3 is an epoxy resin, degree-of-curing measurement unit 70 is a device that calculates the degree of curing by measuring an absorption spectrum of infrared rays by Fourier transform infrared spectroscopy. In the epoxy resin, since a molecular structure changes with the progress of a curing reaction and an epoxy group decreases, peak intensity of the absorption spectrum decreases. A ratio between an unreacted material and a reacted material is measured from a spectral change of the adhesive, in other words, an epoxy group peak intensity ratio is calculated based on peak intensity of a structure that does not contribute to the reaction. Thus, the degree of curing can be measured. Degree-of-curing measurement unit 70 may be of any type as long as the degree of curing of adhesive 3 can be measured. Information on the degree of curing of adhesive 3 measured by degree-of-curing measurement unit 70 is input to controller C1.

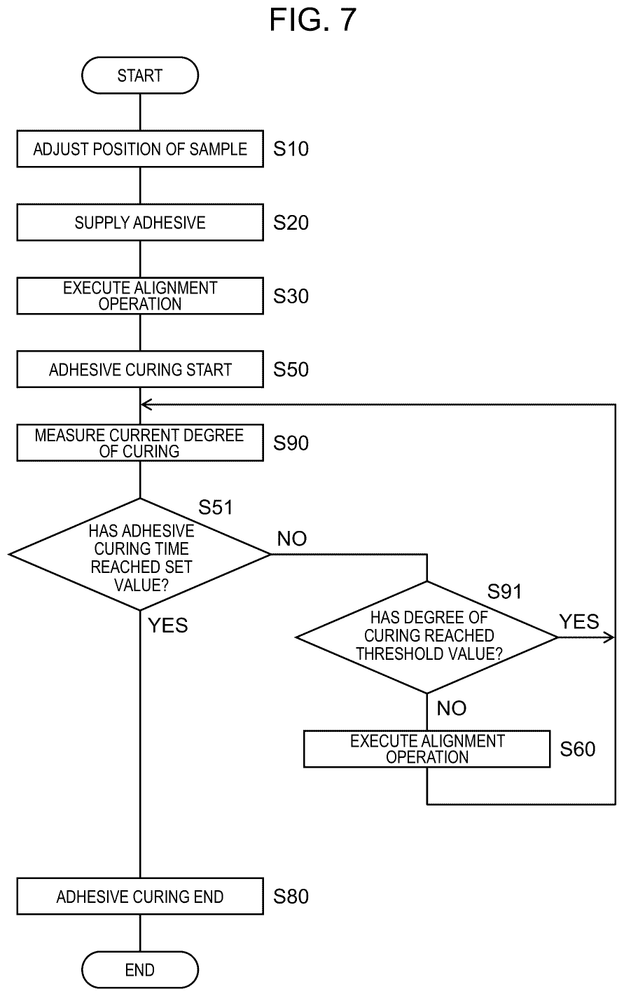

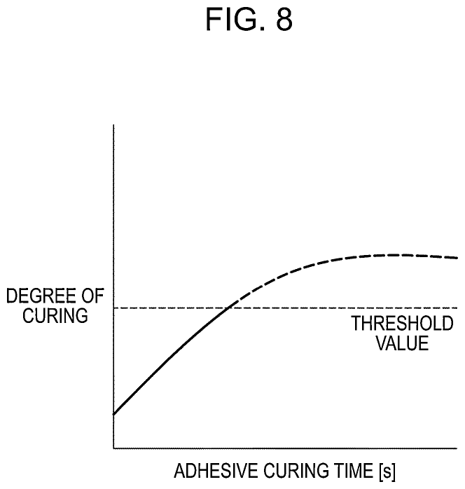

Here, a method for connecting an optical waveguide using optical waveguide connection device D2 according to the second exemplary embodiment will be described with reference to FIGS. 7 and 8. FIG. 7 is a flowchart for explaining a method for connecting an optical waveguide according to the second exemplary embodiment of the present disclosure, and FIG. 8 is a diagram for explaining a change in the degree of curing according to the second exemplary embodiment of the present disclosure.

Step S10, step S20, step S30, and step S50 are the same as the steps in the first exemplary embodiment.

Subsequently, after the curing of adhesive 3 is started (step S50), a current degree of curing of adhesive 3 is measured by degree-of-curing measurement unit 70 (step S90). In a case where an ultraviolet-curable adhesive is used, a photopolymerization initiator absorbs ultraviolet rays at the start of ultraviolet irradiation to generate radicals or cations, and then the radicals or cations are bonded to a monomer or oligomer as a main component of ultraviolet curing to advance a polymerization reaction. At this time, the degree of curing measured by degree-of-curing measurement unit 70 increases with an increase in viscosity in proportion to consumption of the initiator.

Subsequently, in a case where the time detected by adhesive curing time detection mechanism 40a has not reached the set value (step S51, NO), and in a case where the degree of curing of adhesive 3 calculated in step S90 has not reached the threshold value (step S91, NO), the alignment operation of optical fiber block 2 is executed with respect to optical circuit board 1 (step S60), and processing in and after step S50 is repeatedly executed. In step S60, it is possible to correct the positional deviation due to the curing shrinkage of adhesive 3 caused by the curing of adhesive 3.

As illustrated in FIG. 8, as the curing time of adhesive 3 elapses, the viscosity changes, and the resistance value increases. In a case where the degree of curing of adhesive 3 calculated in step S90 has reached the threshold value (step S91, YES), the alignment operation of optical fiber block 2 with respect to optical circuit board 1 is not executed, and when the adhesive curing time has reached the set value (step S51, YES), the curing of adhesive 3 is ended (step S80).

Here, the threshold value of the degree of curing measured in step S90 is, for example, 70%. Note that, the threshold value of the degree of curing is not limited to 70%, and is appropriately set in a range of 50% to 99% depending on the physical properties of adhesive 3 to be used and the shape of optical fiber block 2.

According to the second exemplary embodiment, as described above, step S90, step S51, step S91, and step S60 after step S50 are repeatedly performed, and thus, it is possible to suppress the positional deviation between optical fiber 2a and a light input unit of optical circuit board 1 with a simple configuration regardless of the shape of the adhesion object such as optical fiber block 2, and it is possible to realize highly efficient optical coupling.

In the first or second exemplary embodiment, in the measurement of the degree of curing, the degree of curing of adhesive 3 can be constantly measured until the curing of adhesive 3 is completed.

Although the present disclosure has been fully described in connection with preferable exemplary embodiments with reference to the accompanying drawings, various modifications or corrections are obvious to those skilled in the art. Such variations or modifications are to be understood as being included within the scope of the present disclosure as set forth in the appended scope of claims, as long as such variations and modifications do not depart from the scope of the present disclosure. In addition, changes in the combination or the order of elements in the exemplary embodiment can be achieved without departing from the scope and ideas of the present disclosure.

Note that, by appropriately combining arbitrary exemplary embodiments or modifications among the various exemplary embodiments or modifications described above, the effects of the respective exemplary embodiments or modifications can be achieved. In addition, combinations of exemplary embodiments, combinations of examples, or combinations of exemplary embodiments and examples are possible, and combinations of features in different exemplary embodiments or examples are also possible.

According to the present disclosure, the optical fiber block holding the optical fiber can be aligned with respect to the optical circuit board to maximize the intensity of the light emitted from the optical circuit board while referring to the degree of curing of the adhesive and the adhesive curing time. Accordingly, it is possible to provide the method for connecting an optical waveguide and the optical waveguide connection device capable of suppressing the positional deviation between the optical fiber and the light input unit of the optical circuit board with a simple configuration regardless of the shape of the adhesion object such as the optical fiber block and realizing highly efficient optical coupling.

### INDUSTRIAL APPLICABILITY

The exemplary embodiments of the present disclosure can be suitably used in the method for connecting an optical waveguide and the optical waveguide connection device. In addition, since the optical fiber block and the optical circuit board can be permanently connected with high efficiency, the method for connecting an optical waveguide and the optical waveguide device according to the above aspect of the present disclosure can permanently connect can be applied to fields such as high-speed optical communication, representative examples of which are silicon photonics and high-precision sensing using laser light.

### REFERENCE MARKS IN THE DRAWINGS

1 optical circuit board
2 optical fiber block
2a optical fiber
2b holder
3 adhesive
10 sample stage
11 sample adjustment mechanism
20 optical fiber aligning mechanism
20a motor
20b encoder
20d first fixing unit
20e first movable unit
30 adhesive supply unit
40 adhesive curing unit
40a adhesive curing time detection mechanism
50 light receiving unit
51 light receiving unit aligning mechanism
51d second fixing unit
51e second movable unit
60 resistance measurement unit
70 degree-of-curing measurement unit
100 fixing base
C1 controller
D1, D2 optical waveguide connection device

1. A method for connecting an optical waveguide comprising:
supplying an adhesive to near a light input unit on an optical circuit board;
aligning an optical fiber block holding an optical fiber with respect to the optical circuit board to maximize intensity of light emitted from the optical circuit board;
starting curing of the adhesive;
measuring a degree of curing of the adhesive;
measuring an adhesive curing time during the curing of the adhesive; and
aligning the optical fiber block holding the optical fiber with respect to the optical circuit board to maximize the intensity of the light emitted from the optical circuit board while referring to the degree of curing of the adhesive and the adhesive curing time.

2. The method according to claim 1, wherein the aligning of the optical fiber block in the curing of the adhesive is repeatedly executed in a case where the degree of curing is less than or equal to a certain threshold value.

3. The method according to claim 1, wherein, in the measuring of the degree of curing, the degree of curing is measured by measuring a resistance value applied to the optical fiber block when the optical fiber block is aligned.

4. The method according to claim 1, wherein, in the measuring of the degree of curing, the degree of curing is measured by measuring a ratio between an unreacted material and a reacted material from a spectral change of the adhesive in the curing of the adhesive.

5. The method according to claim 4, wherein, in the measuring of the degree of curing, the degree of curing of the adhesive is constantly measured until the curing of the adhesive is completed.

6. An optical waveguide connection device comprising:
an adhesive supply unit that supplies an adhesive to near a light input unit provided in an optical circuit board;
a light receiving unit that receives light emitted from the optical circuit board;
an optical fiber aligning mechanism that aligns an optical fiber block holding an optical fiber with respect to the optical circuit board to maximize intensity of light received by the light receiving unit in a state where the adhesive is supplied;
an adhesive curing unit that cures the adhesive;
an adhesive curing time detection mechanism that detects a curing time of the adhesive when the adhesive is cured;
a degree-of-curing measurement unit that measures a degree of curing of the adhesive; and
a controller that controls the optical fiber aligning mechanism,
wherein the optical fiber block holding the optical fiber is aligned with respect to the optical circuit board by the optical fiber aligning mechanism to maximize the intensity of the light emitted from the optical circuit board while referring to the degree of curing of the adhesive and the curing time of the adhesive by control of the controller.

7. The optical waveguide connection device according to claim 6, wherein, when the adhesive is cured, in a case where the degree of curing measured by the degree-of-curing measurement unit is less than or equal to a certain threshold value, the optical fiber aligning mechanism aligns the optical fiber block with the optical circuit board to maximize the intensity of the light received by the light receiving unit.

8. The optical waveguide connection device according to claim 6, wherein the degree-of-curing measurement unit measures the degree of curing by measuring a resistance value applied to the optical fiber block when the optical fiber aligning mechanism aligns the optical fiber block.

9. The optical waveguide connection device according to claim 6, wherein the degree-of-curing measurement unit measures the degree of curing by measuring a ratio between an unreacted material and a reacted material from a spectral change of the adhesive when the adhesive curing unit cures the adhesive.
